(19) United States
(12) Patent Application Publication
(10) Pub. No.: US 2002/0167164 A1
(43) Pub. Date: Nov. 14, 2002

(54) Quick-disconnect sill cock flange

(76) Inventors: Mark Anthony Thomas, Amarillo, TX (US); Paul Douglas Thomas, Amarillo, TX (US)

Correspondence Address: Mark Anthony Thomas, Rt. 6 Box 379, Amarillo, TX, 79124, US

(21) Appl. No.: 09/854,451

(22) Filed: May 14, 2001

(51) Int. Cl. F16L 5/00; E04F 19/00

(52) U.S. Cl. 285/46; 285/64

(57) ABSTRACT

A quick-disconnect sill cock flange for allowing the ease of installation and removal of a sill cock (3), having a nipple cartridge body (4) communicating with said sill cock (3) by means of ½″ male iron pipe threads (5), the said nipple cartridge body (4) is hollow and cast with a hex channel (20) the entire length and is fashioned with two o-ring grooves (6), which retain o-rings (8) in a confined address in relation to the interior of a termination flange (9), providing a water tight seal. A termination flange (9) is soldered onto copper tubing (13), to be flush with exterior of building wall. The said copper tubing (13), as well as the said termination flange (9), are secured permanently to the building water system and become absolutely stationary. The said sill cock (3), being attached to the said nipple cartridge body (4), communicates with said termination flange (9), allowing the said sill cock (3), to be drawn up tight by use of a pair of retaining bolts (12) and flat washers (11). Each of the said retaining bolts (12), pass through said flat washers (11), and screw into female threaded taps (10), forcing alignment of the said sill cock (3) by means of alignment notches (18) on each side of the said sill cock (3). Thus achieving a secure leak free, easily detached sill cock assembly.

### CROSS-REFERENCE TO RELATED APPLICATIONS

Not applicable.

### BACKGROUND—FIELD OF INVENTION

This invention relates to sill cocks, more specifically to providing an apparatus to allow a sill cock to be easily and quickly installed and removed from the building water piping system.

### BACKGROUND—DESCRIPTION OF PRIOR ART

The invention herein disclosed pertains to a sill cock which protrudes through the exterior of a building wall, allowing potable water to be easily accessed. There are several patents issued in this arena which attempt to address the challenges of securing the sill cock to prevent movement of the piping in the wall, or damage as a result of freezing, however, none have addressed the problem of removal for the purpose of repair.

The method most commonly used currently is the termination of the potable waiter piping immediately upon penetration through the building wall, and subsequently, a sill cock is then rotated onto the piping until it is secure enough to produce a seal. This functions perfectly, and a proper installation will result with the sill cock mounting flush with the exterior surface of the building. However, once this attachment has been made complete, many times the sill cock must be removed from the piping at a later date to facilitate a repair. As the sill cock is flush with the exterior of the building, there is no access to the pipe in order to hold the pipe from twisting in the wall as the sill cock is rotated off of the pipe. Many times the sill cock requires far more rotating torque to remove the fixture than was required to install it because of the corrosive effects on the pipe and fitting threads, resulting in the concealed portion of the pipe and fittings being twisted and broken off inside of the wall. Obviously, this will create an expensive and time consuming situation, both for the repairman as well as the customer, as the wall must then be opened to locate and repair the broken pipes.

It would be beneficial to have a sill cock which is designed to allow quick removal, and installation for ease of repair without the threat of further damage to the piping system. This need is addressed and satisfied with this present invention.

Inventors have designed termination connectors as well as brackets for securing the pipes at the point of penetration through the well, such as U.S. Pat. No. 5,803,508 issued in 1998 to Lowella, and U.S. Pat. No. 5,385,330 issued in 1995 to Joseph. The patent issued to Lowella simply provides a nipple with a plate attached for securing the pipe in the wall, while the patent issued to Joseph provides a compression sill cock, which requires a bulky flange to be attached over the pipe prior to attaching the sill cock, this causes the sill cock to protrude farther from the building wall making it less attractive.

### SUMMARY

In accordance with the present invention a Quick-Disconnect Sill Cock Flange comprises one nipple cartridge body machined with two o-ring groves having male pipe threads at one end and a tapered termination at the opposing end, the interior of said nipple cartridge is fashioned the entire length to receive a hex wrench, additionally, two o-rings, one termination flange fashioned to receive the nipple cartridge body from the flange side, and also fashioned to receive copper tubing in the opposing end to sweat onto the piping system, two retaining bolts and two flat washers.

Objects and Advantages

Accordingly, several objects and advantages of the present invention are:

(a) to provide a sill cock flange which will require a minimal amount of time and tools to access for repair or replacement of a sill cock.

(b) to provide a sill cock flange which will greatly reduce the possibility of damage to concealed piping while performing a repair or replacement.

(c) to provide a sill cock flange that does not require access to the concealed pipe in order to remove the sill cock

### DRAWING FIGURES

The invention is shown in four separate drawings.

FIG. 1 is an exploded side view of the invention.

FIG. 2 is a perspective view of the invention assembled with a cut-away view.

FIG. 3 is a perspective view of the invention installed in a building wall.

FIG. 4 is a perspective of the invention with a sill cock installed on the nipple cartridge body ready to insert into the sill cock flange.

Reference Numerals in Drawings

3 sill cock with female ½″ iron pipe threads

4 nipple cartridge body

5 ½ male iron pipe threads

6 o-ring grove

7 tapered cartridge termination

8 o-rings

9 sill cock flange

10 female threaded tap

11 flat washer

12 retaining bolt

13 copper tubing

14 elbow

15 house piping

16 strap

17 wood stud

18 alignment notch

19 socket

20 hex channel

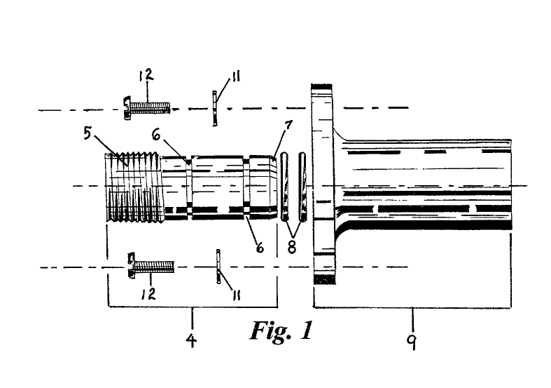

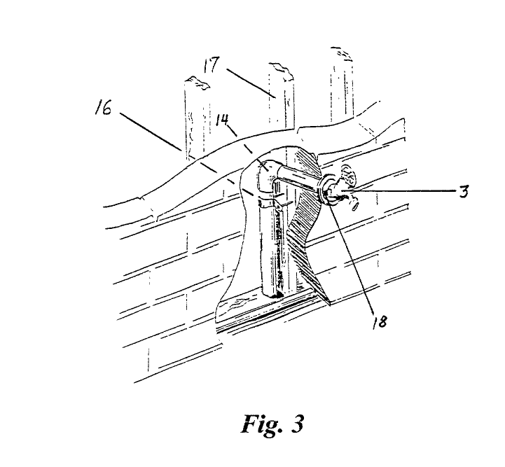

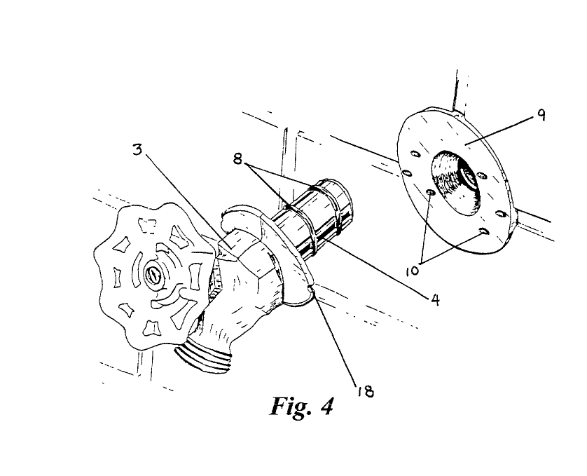

### DESCRIPTION—FIGS. 1, 2, 3 AND 4—PREFERRED EMBODIMENT

A preferred embodiment of the present invention is illustrated in FIGS. 1, 2, 3 and 4. A Quick-Disconnect Sill Cock Flange has a hollow nipple cartridge body 4 constructed of brass, an interior consisting of a hex shaped casting the entire length which allows a ½ inch hex wrench to be inserted into said cartridge body 4 to facilitate installation and removal from a sill cock; said cartridge body 4 also having a length of two and one quarter inches with standard ½″ male iron pipe threads 5, at one end and a tapered cartridge termination 7, at an opposing end, having a major diameter of 0.810 inches, the length thereof and incorporating two o-ring grooves 6, at a minor diameter of 0.710 inches, machined to a width of 0.087 inches, a first o-ring groove 6, being located on a nipple cartridge body 4, at a distance of 1.0 inch from the end of a cartridge body 4 embodying male threads 5, a second o-ring groove 6, being of the same measurements as first said o-ring groove 6, is located 0.75 inches farther down a nipple cartridge body 4. Each of two o-rings 8, having a 0.825 inch outside diameter, with a thickness of 0.070 inches fit into an o-ring groove 6, respectively. A nipple cartridge body 4, is attached to a sill cock 3, and inserted into a termination flange 9, which is fashioned at a length of 2½ inches with a termination flange 9, measuring 0.260 inches in thickness and a diameter of 2.50 inches. A termination flange 9, tapers to an outside diameter of 1.30 inches, A termination flange 9, is hollow with an inside taper from a face with a diameter beginning at 1.30 inches diameter and at a measurement of 0.355 inches tapering to an inside diameter of 0.811 inches and remains said 0.811 inside diameter for a length of 1.90 inches, at which point said inside diameter increases to a measurement of 0.867 inches to a length of 0.60 inches to form a socket 19, to receive copper tubing 13. The face of a termination flange 9, is tapped with a total of six female threads 10, to receive retaining bolts 12, allowing for a variety of sill cocks to be attached. A termination flange 9, is then soldered onto a copper tube 13, which is cut to a desired length at the time of installation to allow a termination flange 9, to rest flush with a finished surface of a building. By making solder or screw joint connections with existing building piping, a copper tubing 13, becomes rigidly affixed to a building, and may then be encased in whatever building material is suitable. As a sill cock 3, and a nipple cartridge body 4, is removed from the rigidly affixed termination flange 9, and copper tubing 13, a faucet grease is applied to the external portion of a nipple cartridge body 4, to allow ease of insertion to functional position. Once a sill cock 3, and a nipple cartridge body 4, is reinserted into a termination flange 9, alignment must be made with female threaded taps 10, which are machined into a termination flange 9, and an alignment notch 18, on a sill cock 3. Once aligned properly, a retaining bolt 12, is passed through a flat washer 11, and through an alignment notch 18, then screwed into a female threaded tap 10, this step is repeated on an opposing side of the invention. A drawing together of a sill cock 3, and a termination flange 9, is accomplished, with o-rings 8, providing a water tight seal between a nipple cartridge body 4, and an interior a termination flange 9.

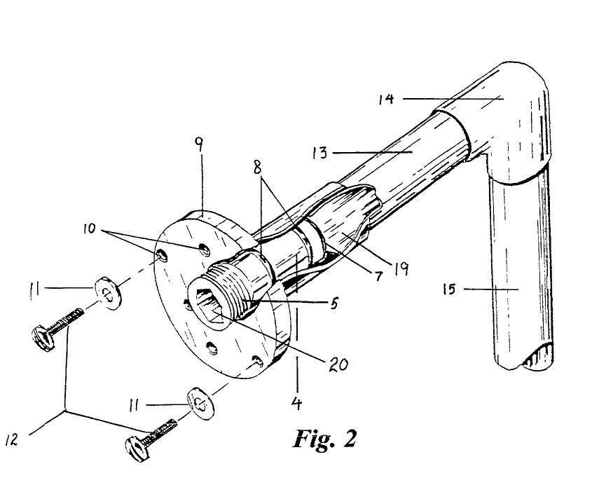

Operation—FIGS. 2, 3 and 4

The manner of using the quick-disconnect sill cock is similar to that in common use today, with the exception being that there is no further need to thread a sill cock onto a pipe which prevents future ease of removal. This invention allows the person performing the removal of the sill cock to simply turn off the water supply and bleed off existing water pressure, then loosen the retaining bolts 12 located on each side of the sill cock 3, remove the flat washers 11, and then gently withdraw the sill cock 3 and nipple cartridge body 4 out of the sill cock flange 9, which leaves the copper tube 13 and the termination flange 9 securely attached to the building. Once repairs are made, new o-rings 8 can be installed into the o-ring grooves 6, grease applied to the exterior of the nipple cartridge body 4, and the sill cock 3 and nipple cartridge body 4 are then ready to be gently inserted back into the termination flange 9. Next, align the alignment notch 18 on each side of the sill cock 3 with the female threaded taps 10 and insert each retaining bolt 12 through each flat washer 11 and screw into the female threaded taps 10. Secure finger tight, and turn water back on to the building.

Conclusion, Ramification, and Scope

Accordingly, the reader will see that the quick-disconnect sill cock of this present invention can be used to accomplish a reliable joining of a sill cock to a building water supply while allowing future removal without damaging the concealed piping.

It permits a permanent stationary installation of the water piping through the building wall.

It allows for ease of removal of the sill cock to repair or replace.

It prevents the possibility of twisting off concealed pipes which are enclosed in the wall.

It saves the repairman and the building owner time and money which would be incurred as a result of a failure due to work done on the old style sill cock.

It prevents the appearance of a repairman “not knowing what he's doing” from occurring, because, the pipe concealed in the wall will not be stressed and broken during a repair.

The scope of this invention should be determined by the appended claims.

I claim:

1. In a quick-disconnect sill cock flange, a nipple cartridge body incorporating two o-rings placed in o-ring grooves on said nipple cartridge body and attached to a sill cock using a pipe joint compound, and inserting said nipple cartridge body with said sill cock into a termination flange which is soldered onto a copper tube, compressing said o-rings into a confined address at each of the said o-ring grooves, and between interior of said termination flange and said nipple cartridge body, thus producing a water tight seal, and further passing two retaining bolts through two flat washers and inserting into female threaded taps to allow screwing down of said retaining bolts causing said flat washers to contact surface of said sill cock and press said sill cock firmly adjacent to said termination flange.

2. The termination flange may be comprised of cast brass allowing said termination flange to be soldered onto said copper tubing.

3. The said cartridge body may also be constructed in all of previous stated dimensions with the exception of the interior, which may be solid, preventing water from passing into said sill cock. This allows for winterizing to prevent freeze damage.

4. The said sill cock flange and said nipple cartridge body may also be cast to the size of a ¾″ nipple and socket size, allowing a ¾″ sill cock to be installed.
